(19) United States
(12) Patent Application Publication
(10) Pub. No.: US 2024/0288222 A1
(43) Pub. Date: Aug. 29, 2024

(54) ELECTRICALLY POWERED FURNACES TO HEAT A FEED AND RELATED METHODS

(71) Applicant: SABIC GLOBAL TECHNOLOGIES B.V., BERGEN OP ZOOM (NL)

(72) Inventors: Subramanian SANKARAN, Houston, TX (US); Joseph William SCHROER, Houston, TX (US); Raul VELASCO PELAEZ, Houston, TX (US); Michael Edward HUCKMAN, Houston, TX (US)

(73) Assignee: SABIC GLOBAL TECHNOLOGIES B.V., BERGEN OP ZOOM (NL)

(21) Appl. No.: 18/292,200

(22) PCT Filed: Jul. 18, 2022
(86) PCT No.: PCT/EP2022/070064

§ 371 Date: Jan. 25, 2024

(30) Foreign Application Priority Data
Jul. 27, 2021 (EP) 21187872.3

(51) Int. Cl. F27D 99/00; C10G 9/24; C10G 9/36; F27D 11/02

(52) U.S. Cl. CPC F27D 99/0006; C10G 9/24; C10G 9/36; F27D 11/02; F27D 2099/0011

(57) ABSTRACT

An electrically powered furnace may include a plurality of heating tubes configured to receive a feed and heat the feed. Each of the plurality of heating tubes may define a longitudinal axis extending between a first end of the heating tube and a second end of the heating tube and a longitudinal passage for the feed to pass through during heating of the feed. The electrically powered furnace may also include a plurality of electrical connections electrically connecting the plurality of heating tubes, and an electrical power source electrically connected to the plurality of electrical connections and configured to supply a voltage to the plurality of electrical connections. The voltage may be greater than or equal to 20 volts. The electrical connections may electrically connect the heating tubes in series, and the furnace may be configured such that processing of the feed occurs in parallel.

### TECHNICAL FIELD

The present disclosure relates to electrically powered furnaces to heat a feed and related methods and, more particularly, to electrically powered furnaces including heating tubes and related methods.

### BACKGROUND

Gas-fired furnaces may be used to produce numerous desired products. In gas-fired furnaces, heat is generated by the combustion of fuel to provide heat for producing many common products, such as petroleum-derived products. For example, natural gas and light gas may be combusted in the gas-fired furnace to provide heat for endothermic reactions common in the production of petroleum-derived products. Combustion of the hydrocarbons in the gas-fired furnace forms carbon dioxide, which is emitted as part of flue gas from the gas-fired furnace. Such emissions may be undesirable in view of current environmental considerations. Many products resulting from heating, such as petroleum-derived products, for example, ethylene propylene, butylenes, benzene, and/or other similar products are major chemical building blocks and may often be produced in large quantities, such as several hundred thousand tons or more per year at a single production facility. As a result, production of such products using gas-fired furnaces may result in an undesirably high emission of carbon dioxide.

An attempt to improve processing devices and related methods is described in U.S. Pat. No. 8,932,435 B2 to Parsche (“the '435 patent”). The '435 patent describes hydrocarbon resource processing devices including a radio frequency (RF) source and an RF applicator coupled to the RF source. According to the '435 patent, the RF applicator includes an electrically conductive base member and first and second electrically conductive elongate members having proximal ends coupled to the base member and extending in a generally parallel spaced-apart relationship. The first and second elongate members have distal ends to receive a hydrocarbon resource therebetween. According to the '435 patent, the RF source and the RF applicator generate electrical fields between the distal ends of the first and second elongate members to perform at least one of heating, dehydrating, cracking and hydrogenation of the hydrocarbon resource.

Applicant has recognized that the devices and methods of '435 patent may still result in a need for systems and methods for producing products that are more efficient and/or more environmentally friendly. For example, although the devices and methods described in the '435 patent may claim to provide gains in efficiency, they may still be less efficient than desired, and further, may result in an undesirably high emission of carbon dioxide.

Accordingly, Applicant has recognized a need for systems and methods for producing products, such as, for example, petroleum-derived products, that are more efficient and/or more environmentally friendly. The present disclosure may address one or more of the above-referenced drawbacks, as well as other possible drawbacks.

### SUMMARY

The present disclosure is generally directed to electrically powered furnaces and related methods and, more particularly, to electrically powered furnaces including heating tubes and related methods. For example, in some embodiments, an electrically powered furnace may include heating tubes positioned to receive a feed and an electrical power source electrically connected to the heating tubes via electrical connections. The electrical power source may provide the heating tubes with a voltage to cause the temperature of the heating tubes to increase via electrical impedance to a temperature sufficient to cause the feed to be heated. At least some embodiments of the systems and methods to heat a feed disclosed herein may result in electrically powered furnaces that are more accurately controllable, more efficient, and/or more environmentally friendly.

According some embodiments, an electrically powered furnace may include a plurality of heating tubes configured to receive a feed and heat the feed. Each of the plurality of heating tubes may define a path between a first end of the heating tube and a second end of the heating tube for the feed to pass through during heating of the feed. The electrically powered furnace also may include a plurality of electrical connections electrically connecting the plurality of heating tubes, and an electrical power source electrically connected to the plurality of electrical connections and configured to supply a voltage to the plurality of electrical connections. The voltage may be greater than or equal to 20 volts.

According to some embodiments, a hydrocarbon heating assembly may include an electrically powered furnace, and the hydrocarbon heating assembly may be one of an electrically powered cracking furnace, a steam methane reformer, or a hydrocarbon heater for dehydrogenation. The electrically powered furnace may include a plurality of heating tubes configured to receive a feed and heat the feed. Each of the plurality of heating tubes may define a path between a first end of the heating tube and a second end of the heating tube for the feed to pass through during heating of the feed. The electrically powered furnace also may include a plurality of electrical connections electrically connecting the plurality of heating tubes, and an electrical power source electrically connected to the plurality of electrical connections and configured to supply a voltage to the plurality of electrical connections. The voltage may be greater than or equal to 20 volts.

According to some embodiments, a method to heat a material feed may include supplying a voltage to one or more heating tubes of an electrically powered furnace to heat the one or more heating tubes. The voltage may be greater than or equal to 20 volts. The method also may include heating the material feed by passing the material feed through the one or more heating tubes.

Still other aspects and advantages of these exemplary embodiments and other embodiments, are discussed in detail herein. Moreover, it is to be understood that both the foregoing information and the following detailed description provide merely illustrative examples of various aspects and embodiments, and are intended to provide an overview or framework for understanding the nature and character of the claimed aspects and embodiments. Accordingly, these and other objects, along with advantages and features of the present disclosure, will become apparent through reference to the following description and the accompanying drawings. Furthermore, it is to be understood that the features of the various embodiments described herein are not mutually exclusive and may exist in various combinations and permutations.

### BRIEF DESCRIPTION OF THE DRAWINGS

The accompanying drawings, which are included to provide a further understanding of the embodiments of the present disclosure, are incorporated in and constitute a part of this specification, illustrate embodiments of the present disclosure, and together with the detailed description, serve to explain principles of the embodiments discussed herein. No attempt is made to show structural details of this disclosure in more detail than can be necessary for a fundamental understanding of the embodiments discussed herein and the various ways in which they can be practiced. According to common practice, the various features of the drawings discussed below are not necessarily drawn to scale. Dimensions of various features and elements in the drawings can be expanded or reduced to more clearly illustrate embodiments of the disclosure.

FIG. 1A schematically illustrates an example heating assembly according to embodiments of the disclosure.

FIG. 1B schematically illustrates another example heating assembly according to embodiments of the disclosure.

FIG. 2 schematically illustrates an example tube section of an electrically powered furnace according to embodiments of the disclosure.

FIG. 3 is a schematic perspective view of a portion of an example electrically powered furnace according to embodiments of the disclosure.

FIG. 4 schematically illustrates an example electrical connection of an example heating tube according to embodiments of the disclosure.

FIG. 5A is a schematic side section view of an example heating tube according to embodiments of the disclosure.

FIG. 5B is a schematic end section view along line B-B of a first end of the heating tube shown in FIG. 5A.

FIG. 5C is a schematic end section view along line C-C of a second end of the heating tube shown in FIG. 5A.

FIG. 6A is a schematic partial end section view showing an example heating tube having an example cross-sectional shape according to embodiments of the disclosure.

FIG. 6B is a schematic partial end section view showing another example heating tube having another example cross-sectional shape according to embodiments of the disclosure.

FIG. 6C is a schematic partial section view showing a further example heating tube having a further example cross-sectional shape according to embodiments of the disclosure.

FIG. 7 is a block diagram of an example method to heat a material feed by passing the material feed through one or more heating tubes of an electrically powered furnace according to embodiments of the disclosure.

FIG. 8 is a schematic view of an electrically powered furnace illustrating that the tubes are in parallel from a process perspective, but in series from an electrical perspective.

### DETAILED DESCRIPTION

The drawings may use like numerals to indicate like parts throughout the several views, the following description is provided as an enabling teaching of exemplary embodiments, and those skilled in the relevant art will recognize that many changes may be made to the embodiments described. It also will be apparent that some of the desired benefits of the embodiments described can be obtained by selecting some of the features of the embodiments without utilizing other features. Accordingly, those skilled in the art will recognize that many modifications and adaptations to the embodiments described are possible and may even be desirable in certain circumstances. Thus, the following description is provided as illustrative of the principles of the embodiments and not in limitation thereof.

The phraseology and terminology used herein is for the purpose of description and should not be regarded as limiting. As used herein, the term “plurality” refers to two or more items or components. The terms “comprising,” “including,” “carrying,” “having,” “containing,” and “involving,” whether in the written description or the claims and the like, are open-ended terms, i.e., to mean “including but not limited to,” unless otherwise stated. Thus, the use of such terms is meant to encompass the items listed thereafter, and equivalents thereof, as well as additional items. The transitional phrases “consisting of” and “consisting essentially of,” are closed or semi-closed transitional phrases, respectively, with respect to any claims. Use of ordinal terms such as “first,” “second,” “third,” and the like in the claims to modify a claim element does not by itself connote any priority, precedence, or order of one claim element over another or the temporal order in which acts of a method are performed, but are used merely as labels to distinguish one claim element having a certain name from another element having a same name (but for use of the ordinal term) to distinguish claim elements.

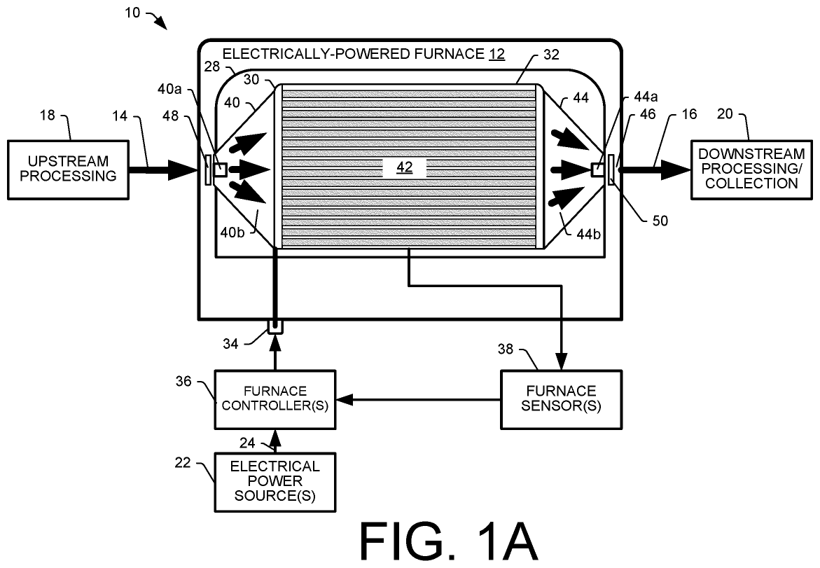

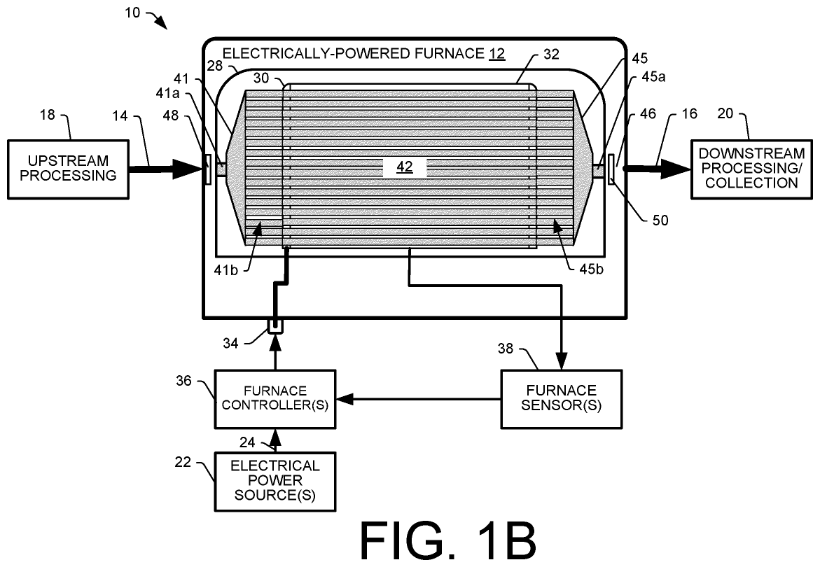

FIG. 1A and FIG. 1B are example heating assemblies 10 according to embodiments of the disclosure. As shown in FIGS. 1A and 1B, the heating assemblies 10 include an electrically powered furnace 12 for receiving a feed 14, which may include any material or materials that are heated during a heating process, and the electrically powered furnace 12 may heat the feed 14 to provide heated products 16, which may include precursors, intermediate products, and/or final products. In some embodiments, the electrically powered furnace 12 may be, or include, any electrically powered heater or heating device for heating a solid, fluid, gas, and/or combination thereof from a first temperature to a second temperature greater than the first temperature. In some embodiments, the electrically powered furnace 12 may be configured to convert electricity into heat sufficient to create endothermic reactions. For example, the feed 14 may include hydrocarbons, and the heating assembly 10 may be a hydrocarbon heating assembly, such as, for example, an electrically powered cracking furnace to produce petroleum-derived products, which may include precursors, intermediate products, and/or final products, a steam methane reformer, a hydrocarbon heater for dehydrogenation, or any other process heating need, for example, any application or process that is capable of accepting heat provided by high voltages and/or high temperatures. Other types of heating assemblies for heating other types of materials are contemplated.

In some embodiments, the heating system 10 shown in FIGS. 1A and 1B may include upstream processing 18 prior to reaching the electrically powered furnace 12. For example, for heating systems 10 used to crack hydrocarbons, the upstream processing 18 may include, for example, a pre-heating section into which a hydrocarbon feed stream and a dilution steam stream may be supplied into pre-heating tubes for combining and pre-heating the hydrocarbon feed stream and the dilution steam stream, for example, as will be understood by those skilled in the art. For example, a hydrocarbon feed stream may include naphtha, ethane, and/or other hydrocarbons, and the electrically powered furnace 12 may at least partially crack the hydrocarbon feed stream to provide cracked hydrocarbons, which may include olefins, methane, and other by-products of the cracking process, as will be understood by those skilled in the art. Other types of upstream processes are contemplated.

As shown in FIGS. 1A and 1B, some embodiments of the heating system 10 may also include downstream processing/collection 20, once the materials of the feed 14 have been heated in the electrically powered furnace 12 to provide heated products 16. In some embodiments, the downstream processing/collection 20 may include additional processing and/or treatment of the heated products 16.

As shown in FIGS. 1A and 1B, in some embodiments, the electrically powered furnace 12 may be supplied with electrical power from the one or more electrical power source(s) 22 via an electric power line 24. The electrical power source(s) 22 may include power generated independently from the heating system 10 and/or power generated during operation of the heating system 10, which may be used to reduce or eliminate electrical power supplied by power generated independently from the heating system 10.

As shown in FIGS. 1A and 1B, the electrically powered furnace 12 may include an outer furnace housing 26 containing therein an electrically powered furnace section 28. For example, as shown in FIGS. 1A and 1B, the electrically powered furnace 12 may include a heating tube section 30, through which the material feed 14 flows during heating to output the heated products 16. As shown in FIGS. 1A and 1B, in some embodiments, the furnace section 28 may include a section housing 32 containing therein the heating tube section 30. In some embodiments, the furnace section 28 may be supplied with electrical power via the power line 24 via one or more terminals 34. The electrical power supplied to the electrically powered furnace 12 may be alternating current (AC) or direct current (DC).

As shown in FIGS. 1A and 1B, in some embodiments, the heating system 10 may include one or more furnace controllers 36 configured to control operation of the electrically powered furnace 12, for example, as will be understood by those skilled in the art. The heating system 10 may further include a plurality of furnace sensor(s) 38, such as, for example, voltage sensors, current sensors, temperature sensors, pressure sensors, flow rate sensors, etc., in communication with the furnace controller(s) 36, and the furnace controller(s) 36 may use control logic in the form of computer software and/or hardware programs to make control decisions associated with controlling operation of electrically powered furnace 12. Some embodiments may include a transformer upstream of the furnace controller(s) 36 to bring the voltage down a level appropriate for operating the electrically powered furnace 12 as intended. In some embodiments, the power may be controlled, for example, via phase angle control, cross-over switching, or other voltage control schemes, as will be understood by those skilled in the art.

In some embodiments, the heating system 10 may include valves associated with the lines and/or conduits, and the furnace controller(s) 36 may communicate control signals based at least in part on the control decisions to control the voltage and/or current supplied to the electrically powered furnace 12, and/or to actuators associated with the valves to control the flow of the feed 14 (e.g., gases and/or liquids) and/or heat, and the actuators may be operated according to the communicated control signals to operate the electrically powered furnace 12 and/or other components of the heating system 10. In some examples, the furnace controller(s) 36 may be supplemented or replaced by human operators at least partially manually controlling the heating system 10 to meet desired performance parameters based at least in part on efficiency considerations and/or emissions considerations.

In some embodiments, as shown in FIG. 1A, the furnace section 30 may include an input plenum 40 configured to receive the feed 14 entering the electrically powered furnace 12 and distribute the feed 14 to the heating tube section 30, including a plurality of heating tubes 42. For example, the input plenum 40 may include a single inlet tube 40a for supplying the feed 14 to an open cavity 40b for supplying the feed 14 from the inlet tube 40a to one or more of the heating tubes 42. In some embodiments, the heating tubes 42 may be configured to receive electrical power from the electrical power source 22 to cause the temperature of the plurality of heating tubes 42 (e.g., the walls) to increase in temperature via electrical impedance, for example, as explained in more detail herein. The feed 14 may flow through the heating tubes 42 of the heating tube section 30 while being heated by the walls of the heating tubes 42. At the end of the heating tubes 42, the heating tube section 30 may include an output plenum 44 in flow communication with the heating tubes 42 and configured to receive the heated products 16 and combine them from the plurality of heating tubes 42 into a single stream to exit the furnace section 28 via an output port 46. For example, the output plenum 44 may include an open cavity 44b for receiving the heated products 16 from one or more of the heating tubes 42 and supplying the heated products 16 to a single outlet tube 44a, which may pass the heated products 16 to the output port 46. In some embodiments, multiple furnace sections may be arranged in series, for example, to heat the feed 14 via more than one heating tube section.

As shown in FIG. 1B, some embodiments of the electrically powered furnace 12 may include headers instead of plenums. For example, as shown in FIG. 1B, the electrically powered furnace 12 may include an input header 41, which may include a single header inlet tube 41a and a plurality of inlet header tubes 41b. The header inlet tube 41a may supply the feed 14 directly to the plurality of inlet header tubes 41b, which supply the feed 14 from the header inlet tube 41a directly to one or more of the heating tubes 42. In some embodiments, the number of inlet header tubes 41b may substantially equal the number of heating tubes 42 of a given furnace section 28. The electrically powered furnace 12 may also include an output header 45, which may include a plurality of outlet header tubes 45b and a single header outlet tube 45a. The plurality of header outlets tubes 45b may receive the heated products 16 directly from one or more of the heating tubes 42 and supply the heated products 16 to the single header outlet tube 45a, which may pass the heated products 16 to the output port 46. In some embodiments, the number of outlet header tubes 45b may substantially equal the number of heating tubes 42 of a given furnace section 28. It is contemplated that some embodiments of the electrically powered furnace 12 may include any combination of plenums and/or headers.

In some embodiments, the electrically powered furnace 12 may include one or more electrical insulators configured to electrically isolate components of the electrically powered furnace 12 from one another and/or from other components of the heating system 10. For example, the electrically powered furnace 12 may include a first insulation ring 48 to electrically insulate the furnace section 28 from a furnace line and/or a second insulation ring 50 to electrically insulate the furnace section 28 from a downstream line for discharge of the heated products 16 and/or another furnace section arranged in series.

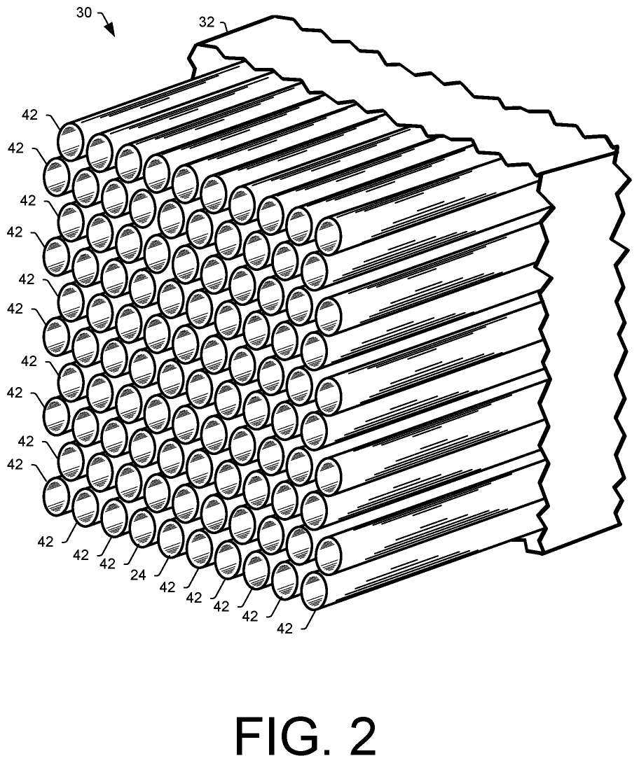

FIG. 2 is a schematic partial perspective section view of a portion of an example electrically powered furnace 12 according to embodiments of the disclosure. In some embodiments, the furnace section 28 may include a heating tube section 30 including a plurality of heating tubes 42, as shown in FIG. 2. For example, the heating tubes 42 may be contained in the section housing 32. In some embodiments, the heating tubes 42 may be substantially parallel to one another, for example, as shown. In some embodiments, the fluid flow in the of heating tubes 42 may be arranged such that the heating tubes 42 are substantially parallel. In the embodiment shown in FIG. 2, the heating tube section 30 includes one-hundred heating tubes 42 arranged in ten rows of ten heating tubes 42. Heating tube sections 30 having a different number of heating tubes 42 and/or a different arrangement of heating tubes 42 are contemplated. In the embodiment of heating tube section 30 shown in FIG. 2, the heating tube section 30 is arranged, such that the heating tubes 42 are substantially horizontal. Some embodiments of heating tube section 30 may have different orientations, for example, ranging from horizontal to vertical.

In some embodiments, the heating tubes 42 may be formed from a material or combination of materials, such that upon receipt of electrical power, the electrical impedance of the heating tubes 42 causes the temperature of the heating tubes 42 to increase to ranges of temperatures sufficient to heat the feed 14, which, in some embodiments, may cause endothermic reactions, for example, leading to the cracking of a hydrocarbon vapor and steam. In some embodiments, the heating tubes 42 may be formed from nichrome, INCONEL®, and/or any material or combinations of materials having similar properties and characteristics, such as similar electrical properties (e.g., electrical-resistance properties), similar heat transfer properties, similar corrosion-resistant properties, a similar or high melting point, and/or similar cracking surface properties. In some embodiments, a voltage ranging from about 20 volts to about 11,000 volts, about 60 volts to about 11,000 volts, about 100 volts to about 11,000 volts, about 200 volts to about 11,000 volts, about 500 volts to about 11,000 volts, about 1,000 volts to about 11,000 volts, about 2,000 volts to about 11,000 volts, etc. may be supplied to the heating tubes 42, thereby causing the temperature of the heating tubes 42 to increase via electrical impedance to a higher temperature. In some embodiments, the voltage applied to the heating tubes 42 may be greater than or equal to 60 volts, greater than or equal to 100 volts, greater than or equal to 400 volts, greater than or equal to 1,000 volts, greater than or equal to 3,000 volts, or greater than or equal to 4,000 volts. In some embodiments, the voltage sufficient to provide the heating tubes 42 to reach a desirable temperature may depend at least in part on the heating tubes 42, a predetermined magnitude of electrical current passing through each of the heating tubes 42, and/or a predetermined voltage supplied to each of the heating tubes 42. In some embodiments, the voltage may cause the temperature of the heating tubes 42 to increase to a temperature ranging from about 100 degrees Celsius (C) to about 1,200 degrees C., to increase to a temperature greater than or equal to 200 degrees C., greater than or equal to 300 degrees C., greater than or equal to 400 degrees C., greater than or equal to 500 degrees C., or greater than or equal to 600 degrees C.

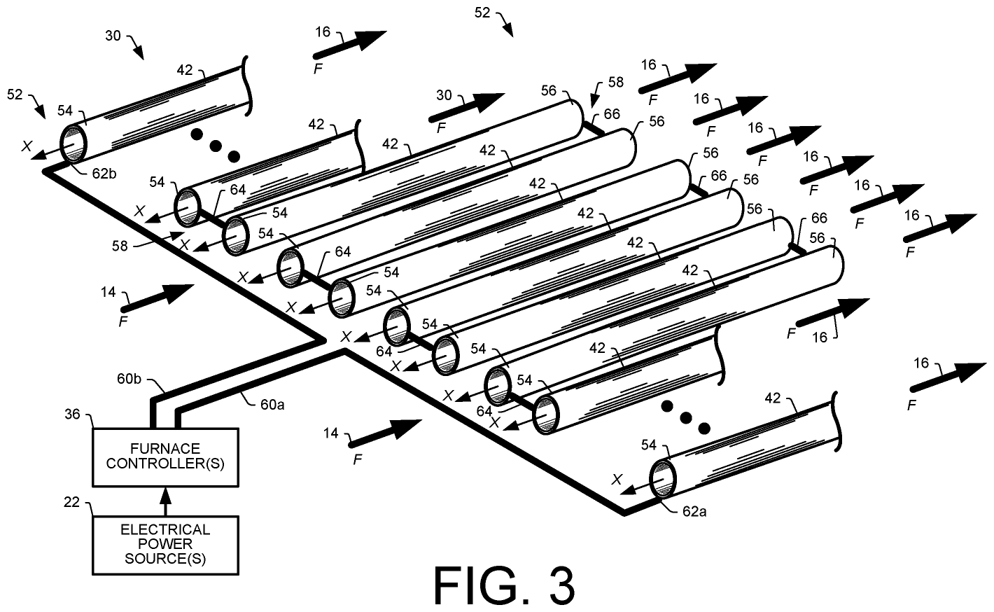

FIG. 3 is a schematic perspective view of example heating tubes 42 of an electrically powered furnace 12 according to embodiments of the disclosure. As shown in FIG. 3, some embodiments of the heating tube sections 30 may include a plurality of electrical connections 52 electrically connecting the plurality of heating tubes 42 in series. For example, as shown in FIG. 3, the feed 14 may flow into the heating tubes 42 in a flow direction from left to right as depicted by the arrows F, and the heating tubes 42 may be arranged such that longitudinal axes X of the heating tubes 42 extending between respective first ends 54 of the heating tubes 42 and second ends 56 of the heating tubes 42 are substantially parallel.

Although the longitudinal axes X of the heating tubes 42 shown in FIGS. 1A, 1B, 2, and 3 are straight, in some embodiments, the longitudinal axes may have other configurations, such as curved and/or bent, for example, such that the heating tubes are curved to follow the axes. For example, the longitudinal axes may be U-shaped or W-shaped, and the heating tubes may be U-shaped or W-shaped, respectively, to follow the longitudinal axes. Other configurations of the longitudinal axes and the heating tubes are contemplated.

In some embodiments, the heating tubes 42 may be electrically connected in series such that electrical impedance of the heating tubes 42 results in heating of the heating tubes 42 to cause the feed 14 to be heated to provide the heated products 16. In some embodiments, the heating tubes 42 may be heated to a temperature, for example, sufficient to crack hydrocarbon vapor and steam and/or to reform hydrocarbons. As shown in FIG. 3, the electrical power source(s) 22 may provide electrical power to the one or more furnace controller(s) 36 to provide electrical power to the heating tubes 42 to control the temperature and/or heat input to the heating tubes 42 to heat the feed 14.

As shown in FIG. 3, some embodiments of the heating tube section 30 may include a plurality of electrical connections 52 in the form of electrical couplers 58 positioned and configured to electrically connect adjacent heating tubes 42 in series. For example, as shown in FIG. 3, the heating tube sections 30 (see also FIG. 2) may include a plurality of rows of heating tubes 42 arranged adjacent one another, and an electrical coupler 58 may electrically connect two adjacent heating tubes 42 to one another, for example, as shown in FIG. 3. An electrical conductor 60a may electrically connect the electrical power source(s) 22 to a first terminal 62a (via the furnace controller(s) 36) to one of the plurality of heating tubes 42. In some embodiments, the first terminal 62a may be connected to a heating tube 42 at an end of a row or other arrangement of heating tubes 42. In some embodiments, a second electrical conductor 60b may electrically connect the electrical power source(s) 22 to a second terminal 62b (via the furnace controller(s) 36) to one of the plurality of heating tubes 42. In some embodiments, the second terminal 62bmay be connected to a heating tube 42 at an end of a row or other arrangement of heating tubes 42. In some embodiments, the heating tube section 30 may include multiple layers or rows of heating tubes 42 that are electrically connected to one another, for example, in series. In some embodiments, each of multiple layers of the heating tubes 42 may be electrically connected to one another in parallel (or series). Other heating tube arrangements and/or electrical connections are contemplated.

As shown, in some embodiments, the first terminal 62a may be connected to a first end 54 of the heating tube 42. In some embodiments, the heating tube sections 30 may include intermediate electrical couplers configured to electrically connect adjacent heating tubes 42 to one another. For example, a first intermediate electrical coupler 64 may electrically connect first ends 54 of two adjacent heating tubes 42 to one another. A second intermediate electrical coupler 66 may electrically connect second ends 56 of two adjacent heating tubes 42 to one another. The first and second intermediate couplers 64 and 66 may alternate electrically coupling heating tubes 42 to one another such that a layer of heating tubes 42 are electrically connected in series to one another, for example, as shown in FIG. 3. In some embodiments, the electrical connections 52 may be configured to electrically connect a first subset of the first ends 54 of the heating tubes 42 to one another and a second subset of the second ends 56 of the heating tubes 42 to one another, thereby electrically connecting the plurality of heating tubes 42 in series. In some such embodiments, the first subset and the second subset may alternate, for example, as shown in FIG. 3.

In some embodiments, the intermediate electrical couplers 64 and 66 may be formed from an electrically conductive material. In some embodiments, the intermediate electrical couplers 64 and 66 may be secured to corresponding heating tubes 42 via a mechanical connection, such as, for example, bolts, set screws, welding, and/or adhesives. In some embodiments, the intermediate electrical couplers 64 and 66 may be configured to be secured to corresponding heating tubes 42, such that the intermediate electrical couplers 64 and 66 may be disconnected or separated from the heating tubes 42, for example, during maintenance or repair, so that one or more of the adjacent the heating tubes 42 may be separated from the heating tube section 30 without removing other heating tubes 42 from the heating tube section 30.

Although FIGS. 1A, 1B, 2, and 3 show embodiments in which the heating tubes 42 are physically arranged parallel to one another (e.g., at least portions of the longitudinal axes are parallel to one another), some embodiments may include one or more heating tubes 42, or groups of heating tubes 42, that are not physically parallel to one another. In some such embodiments, the heating tubes 42, or groups of heating tubes 42, may still be electrically connected in series. For example, in some embodiments, at least some of the heating tubes 42 (e.g., all of the heating tubes 42) may be electrically connected in series, while at least some of the heating tubes 42 (e.g., all of the heating tubes 42) may be connected in parallel with respect to processing the feed 14, for example, such that each of a plurality of portions of the feed 14 passes through one of the heating tubes 42 of a heating tube section 30 from an inlet end to an outlet end of the respective heating tube 42. Although, in some embodiments, at least some of the heating tubes 42 may be in parallel with respect to processing the feed 14, at least some of the heating tubes 42 may not be physically in parallel with respect to one another, for example, such that at least some of the heating tubes 42 are physically skewed with respect to one another. In some embodiments, a first group of the heating tubes 42 may be physically parallel with respect to one another, for example, having at least portions of longitudinal axes that are parallel to one another, and one or more additional groups of the heating tubes 42 may be physically parallel with respect to one another, with the first group of heating tubes 42 not being physically parallel to one or more of the additional groups of heating tubes 42. In at least some such embodiments, the first group of heating tubes 42 and one or more of the additional groups of heating tubes 42 may be in parallel with one another with respect to processing the feed 14.

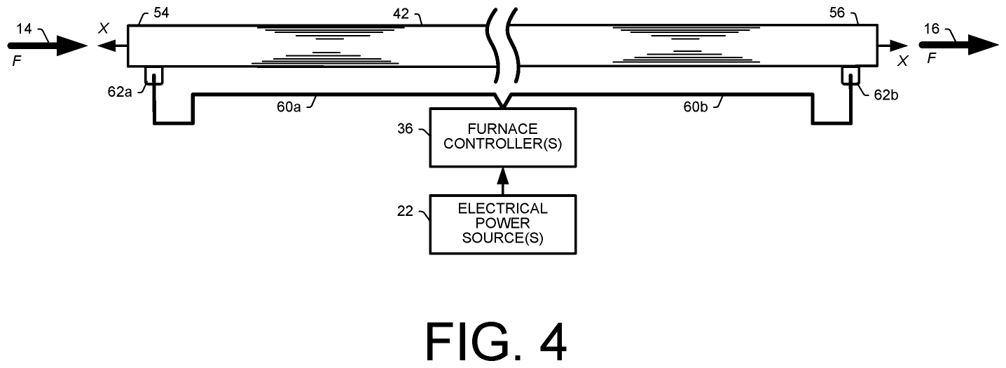

FIG. 4 schematically illustrates an example electrical connection of an example heating tube 42 according to embodiments of the disclosure. In the embodiment shown in FIG. 4, one or more electrical power source(s) 22 may supply electrical power to one or more of the heating tubes 42, for example, as controlled by one or more furnace controller(s) 36. As shown in FIG. 4, a first electrical conductor 60a may electrically connect the furnace controller(s) 36 to a first terminal 62a, which is connected to the first end 54 of a heating tube 42. A second electrical conductor 60b may electrically connect the one or more electrical power source(s) 22 to a second terminal 62b, which is connected to the second end 56 of a heating tube 42. In the embodiment shown in FIG. 4, the feed 14 flows through the heating tube 42 from the first end 54 toward the second end 56 as depicted by the arrows F. The embodiment shown in FIG. 4 includes an example of a heating tube 42 electrically connected, such that electrical impedance causes the temperature and/or heat flux of the heating tube 42 to increase, such that feed 14 flowing through the heating tube 42 is heated (e.g., for some hydrocarbon feeds, partially or fully cracked).

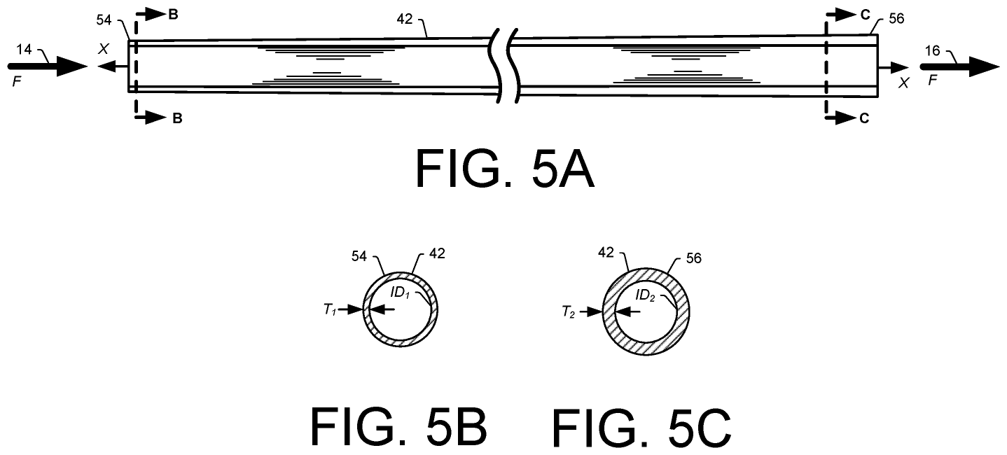

FIG. 5A is a schematic side section view of an example heating tube 42 according to embodiments of the disclosure, and FIG. 5B and FIG. 5C are a schematic section end view along line B-B of a first end 54 of the heating tube 42 shown in FIG. 5A, and a schematic section end view along line C-C of a second end 56 of the heating tube 42 shown in FIG. 5A, respectively. In some embodiments, the heating tube 42 may be configured such that an electrical resistance of one or more of the heating tubes 42 of a heating tube section 30 (FIGS. 1 and 2) may vary between the first end 54 and the second end 56, causing a heat input of the heating tube 42 to vary between the first end 54 and the second end 56. For example, one or more of the heating tubes 42 may define a wall thickness, a cross-sectional area, a cross-sectional shape, and/or a surface relief that varies between the first end 54 and the second end 56, causing the heat input of the heating tube 42 to vary between the first end 54 and the second end 56. In some embodiments, one or more of the heating tubes 42 may include (e.g., be formed from) one or more materials having a conductivity property that varies between the first end 54 and the second end 56, causing the heat input of the one or more heating tubes 42 to vary between the first end 54 and the second end 56.

For example, one or more of the heating tubes 42 may be configured such that the first end 54 of the heating tube 42 has a greater heat input than the second end 56 of the heating tube 42. In some embodiments, this may result in a more even distribution of temperature of the heating tube 42 along its length. For example, when the feed 14 enters the first end of the heating tube 42, the temperature of the feed 14, prior to being heated in the heating tube 42, is relatively lower as compared to the temperature of the heated products 16 exiting the second end 56 of the heating tube 42 after passing through the heating tube 42 and being heated. Thus, if the heat input into the heating tube 42 is relatively uniform along its length between the first end 54 and the second end 56, the temperature of the second end 56 of the heating tube 42 will be greater than the first end 54 due, for example, to the temperature of the heated products 16 being higher at the second end 56 of the heating tube 42, thereby resulting in the temperature of the second end 56 of the heating tube 42 being higher than the first end 54 of the heating tube 42.

In some embodiments, the heating tube 42 may be configured such that the first end 54 of the heating tube 42 has a greater heat input than the second end 56 of the heating tube 42, which may result in the temperature of the second end 56 of the heating tube 42 being closer to the temperature of the first end 54 of the heating tube 42, and, in some embodiments, which may result in a temperature profile of the heating tube 42 being more consistent along the length of the heating tube 42. In some embodiments, the heating tube 42 may be configured such the first end 54 of the heating tube 42 has a greater electrical resistance (or lower electrical conductivity) than the second end 56 of the heating tube 42, which may result in a greater heat input to the first end 54 of the heating tube 42 than the second end 56 of the heating tube 42. In some embodiments, the electrical resistance of the heating tube 42 may be configured (e.g., in physical dimensions, shapes, and/or material content), such that the electrical resistance of the heating tube 42 varies along the length of the heating tube 42 between the first end 54 and the second end 56, to provide a desired temperature profile and/or heat input profile. For example, in some embodiments, the temperature profile and/or the heat input profile may vary and decrease gradually from a first temperature and/or first heat input at the first end 54 to a second temperature and/or second heat input at the second end 56. In some embodiments, the temperature profile and/or the heat input profile may vary and decrease in a step-wise manner from a first temperature and/or first heat input at the first end 54 to a second temperature and/or second heat input at the second end 56.

In the embodiment shown in FIGS. 5A, 5B, and 5C, the heating tube 42 has a circular cross-section 68 extending from the first end 54 to the second end 56 of the heating tube 42, but the wall thickness T gradually increases from the first end 54 to the second end 56, for example, as shown (e.g., T₁<T₂). In some embodiments, for example, as shown, the inner diameter ID may be constant (e.g., ID₁=ID₂). In some embodiments, the inner diameter may either increase or decrease, while the wall thickness increases, such that the electrical resistance of the heating tube 42 decreases from the first end to the second end 56.

In some embodiments, one or more heating tubes 42 of a tube section 30 may include heating tubes 42 arranged in different relative arrangements as viewed from the end of the tube section 30. In some embodiments, an interior passage and/or an exterior surface of one or more of the heating tubes 42 may have a cross-sectional area and/or a cross-sectional shape that is the same as the cross-sectional area and/or the cross-sectional shape of one or more others of the heating tubes 42. In some embodiments, the interior passage and/or the exterior surface of one or more of the heating tubes 42 may have a cross-sectional area and/or a cross-sectional shape that differs from the cross-sectional area and/or the cross-sectional shape of one or more others of the heating tubes 42. In some embodiments, the interior passage and/or the exterior surface of one or more of the heating tubes 42 may have a cross-sectional shape transverse to the longitudinal axis X (also referred to as a path) that is substantially circular. The heating tubes 42 are not limited to cylindrical-shaped tubes and/or cylindrical-shaped interior passages. In some embodiments, the interior passage and/or the exterior surface of one or more of the heating tubes 42 may have a cross-sectional shape transverse to the longitudinal axis X that is substantially elliptical, oval-shaped, oblong, or rectangular (e.g., rectangular-and/or square-shaped). In some embodiments, the interior passage and/or the exterior surface of one or more of the heating tubes 42 may have a cross-sectional shape transverse to the longitudinal axis X that is substantially polygonal, such as, for example, substantially octagonal or substantially hexagonal, a combination of curved-and polygonal-shaped, or any cross-sectional shape suitable for a conduit. The cross-sectional shapes and/or the cross-sectional sizes may be tailored at least partially based on, for example, heat transfer, temperature profile, heat input profile, and/or efficiency considerations.

In some embodiments, the heating tubes 42 may have a substantially constant cross-sectional shape, a substantially constant cross-sectional size, and/or a substantially constant surface configuration (e.g., relief, texture, cladding (e.g., foil), coating (e.g., paint), etc.) from the first end 54 to the second end 56. In some embodiments, the heating tubes 42 may have a varying cross-sectional shape, a varying cross-sectional size, and/or a varying surface configuration from the first end 54 to the second end 56. In some embodiments, the cross-sectional shape, the cross-sectional size, and/or the surface configuration may be tailored to provide a desired heat transfer, temperature profile, heat input profile, and/or efficiency along the length of the heating tube 42.

In some embodiments, electrical insulation and/or thermal insulation may be provided in at least a portion of the volume of the tube sections 30 between the heating tubes 42. In some examples, the insulation may be an air gap, ceramic insulation, and/or other forms of thermal and/or electrical insulation.

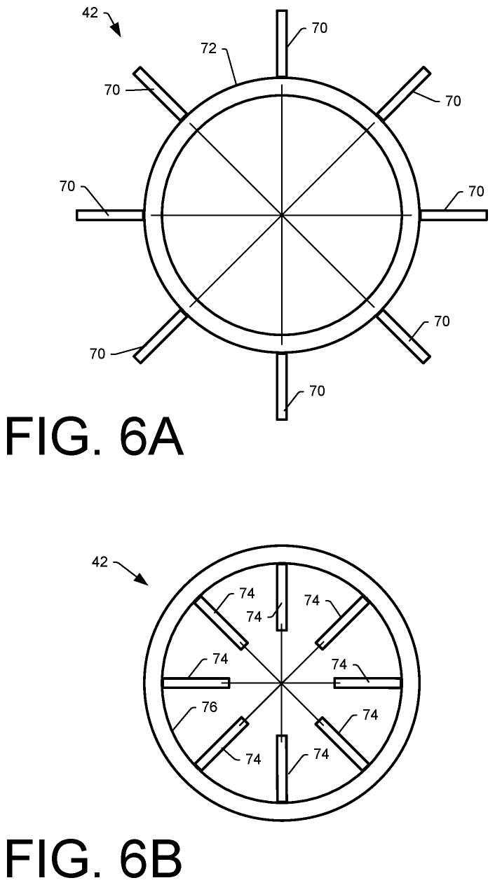

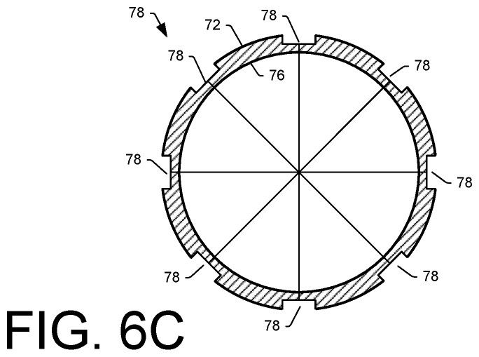

FIGS. 6A, 6B, and 6C are schematic partial end section views showing example heating tubes 42 having example cross-sectional shapes and/or surface configurations according to embodiments of the disclosure. For example, as shown in FIG. 6A, some embodiments of the heating tubes 42 may include a plurality of fins 70 circumferentially-spaced and extending from the exterior surface 72 of the heating tube 42. As shown in FIG. 6B, some embodiments of the heating tubes 42 may include a plurality of fins 74 circumferentially-spaced and extending from the interior surface 76 of the heating tube 42. Some embodiments may include fins on both the exterior surface 72 and the interior surface 76 of the heating tube 42. In some embodiments, the fins 70 and/or 74 may be configured to vary the electrical resistance of the heating tube 42 between the first end 54 and the second end 56, for example, as explained previously herein. For example, the number, the length, and/or the thickness of the fins 70 and/or 74 may vary with the length of the heating tube 42 between the first end 54 and the second end 56 of the heating tube 42.

As shown in FIG. 6C, some embodiments of the heating tubes 42 may include a surface relief tailored to provide a desired temperature profile and/or heat input profile along the length of the heating tube 42. For example, as shown in FIG. 6C, some embodiments of the heating tubes 42 may include a plurality of recesses 78 circumferentially-spaced and extending into the exterior surface 72 of the heating tube 42. In some embodiments, recesses 78 may be provided on the interior surface 76 of the heating tube 42 or on both the exterior surface 72 and the interior surface 76. In some embodiments, the recesses 78 may extend partially, intermittently, or substantially the entire length of the heating tube 42. In some embodiments, the recesses 78 may change in number, shape, width, and/or depth along the length of the heating tube 42 between the first end 54 and the second end 56. In some embodiments, the number, the shape, the width, and/or the depth of the recesses 78 may be configured to vary the electrical resistance of the heating tube 42 between the first end 54 and the second end 56, for example, as explained previously herein.

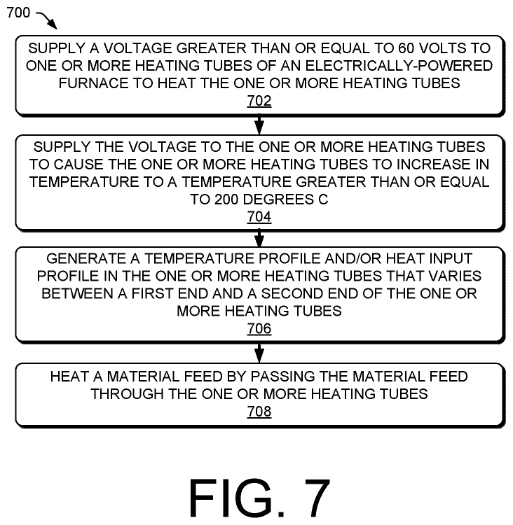

FIG. 7 is a block diagram of an example method 700 to heat a material feed, according to embodiments of the disclosure, illustrated as a collection of blocks in a logical flow graph, which represent a sequence of operations. The order in which the operations are described is not intended to be construed as a limitation, and any number of the described blocks may be combined in any order and/or in parallel to implement the method.

FIG. 7 is a block diagram of an example method 700 to heat a material feed by passing the material feed through one or more heating tubes of an electrically powered furnace, according to embodiments of the disclosure. For example, the material feed may include, but is not limited to, hydrocarbons, and the heating of the material feed may be part of a process to crack the hydrocarbons, for example, as part of a hydrocarbon cracking process, part of a process to produce hydrogen, for example, as part of a methane reformation process, or as part of a dehydrogenation process. Other types of feeds and/or heating processes are contemplated.

The example method 700, at 702, may include supplying a voltage to one or more heating tubes of an electrically powered furnace to heat the one or more heating tubes. For example, the voltage may be greater than or equal to 60 volts. In some embodiments, the voltage may be supplied to the one or more heating tubes via electrical connections in series.

At 704, the example method 700 may include supplying the voltage to the one or more heating tubes to cause the one or more heating tubes to increase in temperature to a temperature greater than or equal to 200 degrees C.

At 706, the example method 700 may include generating a temperature profile and/or heat input profile in the one or more heating tubes that varies between a first end of the one or more heating tubes and a second end of the one or more heating tubes. For example, the one or more heating tubes may be configured such that the electrical resistance in the one or more heating tubes varies along the length of the heating tubes, for example, as previously described herein.

In some embodiments, supplying the voltage to the one or more heating tubes may include supplying a voltage greater than or equal to 100 volts, greater than or equal to 400 volts, greater than or equal to 1,000 volts, greater than or equal to 3,000 volts, or greater than or equal to 10,000 volts.

In some embodiments, causing the one or more heating tubes to increase in temperature may include causing the temperature to increase to a temperature greater than or equal to 200 degrees C., greater than or equal to 300 degrees C., greater than or equal to 400 degrees C., greater than or equal to 500 degrees C., greater than or equal to 600 degrees C. or greater than or equal to 700 degrees C.

The example method 700, at 708, may include heating a material feed by passing the material feed through the one or more heating tubes. In some embodiments, the one or more of the heating tubes may be arranged to provide respective flow paths in parallel with respect to one another, for example, as previously described herein.

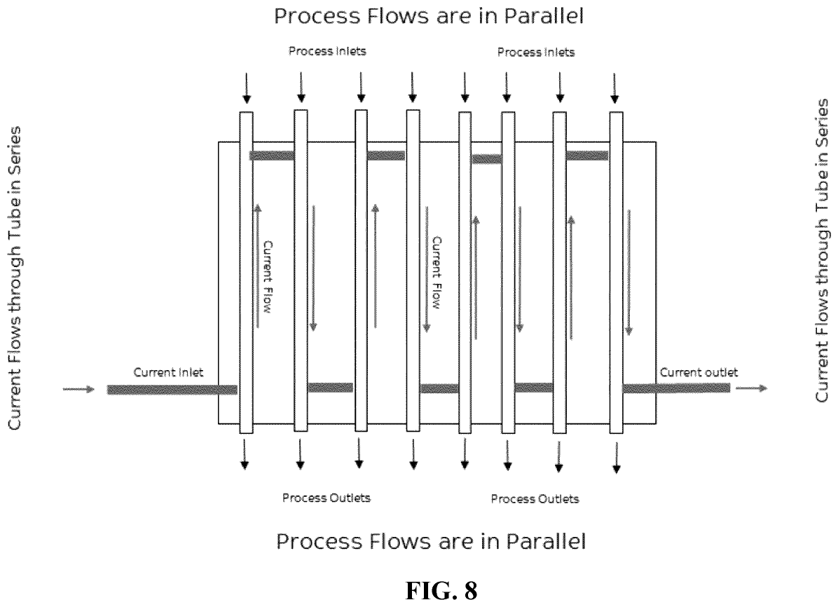

FIG. 8 is a schematic view of an electrically powered furnace illustrating that the tubes and/or process flows through said tubes are substantially parallel from a process perspective, but are in series from an electrical perspective.

Having now described some illustrative embodiments of the disclosure, it should be apparent to those skilled in the art that the foregoing is merely illustrative and not limiting, having been presented by way of example only. Numerous modifications and other embodiments are within the scope of one of ordinary skill in the art and are contemplated as falling within the scope of the disclosure. In particular, although many of the examples presented herein involve specific combinations of method acts or system elements, it should be understood that those acts and those elements may be combined in other ways to accomplish the same objectives. Those skilled in the art should appreciate that the parameters and configurations described herein are exemplary and that actual parameters and/or configurations will depend on the specific application in which the systems and techniques of the disclosure are used. Those skilled in the art should also recognize or be able to ascertain, using no more than routine experimentation, equivalents to the specific embodiments of the disclosure. It is, therefore, to be understood that the embodiments described herein are presented by way of example only and that, within the scope of any appended claims and equivalents thereto, the embodiments of the disclosure may be practiced other than as specifically described.

Furthermore, the scope of the present disclosure shall be construed to cover various modifications, combinations, additions, alterations, etc., above and to the above-described embodiments, which shall be considered to be within the scope of this disclosure. Accordingly, various features and characteristics as discussed herein may be selectively interchanged and applied to other illustrated and non-illustrated embodiment, and numerous variations, modifications, and additions further can be made thereto without departing from the spirit and scope of the present disclosure as set forth in the appended claims.

What is claimed is:

1. An electrically powered furnace comprising:
a plurality of heating tubes configured to receive a feed and heat the feed, each of the plurality of heating tubes defining a path between a first end of the heating tube and a second end of the heating tube for the feed to pass through during heating of the feed, wherein the fluid flow in the plurality of heating tubes is substantially parallel;
a plurality of electrical connections electrically connecting the plurality of heating tubes, wherein the plurality of electrical connections electrically connects the plurality of heating tubes in series; and
an electrical power source electrically connected to the plurality of electrical connections and configured to supply a voltage to the plurality of electrical connections, the voltage being greater than or equal to 100 volts.

2. The electrically powered furnace of claim 1, wherein voltage is greater than or equal to 400 volts, greater than or equal to 1,000 volts, greater than or equal to 3,000 volts, or greater than or equal to 10,000 volts.

3. The electrically powered furnace of claim 1, wherein the voltage causes a temperature of the plurality of heating tubes to increase to a temperature greater than or equal to 200 degrees C., greater than or equal to 300 degrees C., greater than or equal to 400 degrees C., greater than or equal to 500 degrees C., greater than or equal to 600 degrees C., or greater than or equal to 700 degrees C.

4. The electrically powered furnace of claim 1, wherein an electrical resistance of one or more of the plurality of heating tubes varies between the first end and the second end, causing a heat input of the plurality of heating tubes to vary between the first end and the second end.

5. The electrically powered furnace of claim 1, wherein the one or more of the plurality of heating tubes defines one or more of a wall thickness, a cross-sectional area, a cross-sectional shape, or a surface relief that varies between the first end and the second end, causing the electrical resistance of the one or more heating tubes to vary between the first end and the second end, such that the heat input of the one or more heating tubes varies between the first end and the second end.

6. The electrically powered furnace of claim 1, wherein the one or more of the plurality of heating tubes comprises one or more materials having a conductivity property that varies between the first end and the second end, causing the heat input of the one or more heating tubes to vary between the first end and the second end.

7. The electrically powered furnace of claim 1, wherein the electrically powered furnace is a steam cracking furnace.

8. The electrically powered furnace of claim 1, wherein the electrically powered furnace is a steam methane reformer.

9. The electrically powered furnace of claim 1, wherein the electrically powered furnace is a hydrocarbon heater for dehydrogenation.

10. The electrically powered furnace of claim 1, further comprising a feed pre-treatment assembly configured to treat a hydrocarbon feed stream to provide a treated feed stream.

11. A method to heat a material feed, the method comprising:
supplying a voltage to two or more heating tubes of an electrically powered furnace to heat the two or more heating tubes, the voltage being greater than or equal to 100 volts, wherein the fluid flow in the two or more heating tubes is substantially parallel, and wherein a plurality of electrical connections between the two or more heating tubes electrically connects the two or more heating tubes in series; and
heating a feed by passing the feed through the two or more heating tubes.

12. The method of claim 11, wherein supplying the voltage to the two or more heating tubes comprises supplying a voltage greater than or equal to 400 volts, greater than or equal to 1,000 volts, greater than or equal to 3,000 volts, or greater than or equal to 10,000 volts.

13. The method of claim 11, wherein supplying the voltage to the two or more heating tubes causes the two or more heating tubes to increase in temperature to a temperature greater than or equal to 200 degrees C., greater than or equal to 300 degrees C., greater than or equal to 400 degrees C., greater than or equal to 500 degrees C., greater than or equal to 600 degrees C., or greater than or equal to 700 degrees C.

14. The method of claim 11, wherein supplying the voltage to the two or more heating tubes generates one or more of a temperature profile or a heat input in the two or more heating tubes that varies between first ends of the two or more heating tubes and second ends of the two or more heating tubes.

15. The method of claim 12, wherein the feed is a hydrocarbon feed.

16. The method of claim 13, wherein the feed is a hydrocarbon feed.

17. The method of claim 14, wherein the feed is a hydrocarbon feed.

18. The method of claim 15, wherein the feed is a hydrocarbon feed.

19. The method of claim 12, wherein supplying the voltage to the two or more heating tubes causes the two or more heating tubes to increase in temperature to a temperature greater than or equal to 200 degrees C., greater than or equal to 300 degrees C., greater than or equal to 400 degrees C., greater than or equal to 500 degrees C., greater than or equal to 600 degrees C., or greater than or equal to 700 degrees C.

20. The electrically powered furnace of claim 2, further comprising a feed pre- treatment assembly configured to treat a hydrocarbon feed stream to provide a treated feed stream.
